(19) United States
(12) Patent Application Publication
(10) Pub. No.: US 2006/0007681 A1
(43) Pub. Date: Jan. 12, 2006

(54) Flashlight having function of indicating directions

(76) Inventor: Jerry Song, Taipei City (TW)

Correspondence Address: Jerry Song, P.O. Box 90, Tainan City, 704, TW

(21) Appl. No.: 10/886,693

(22) Filed: Jul. 9, 2004

(51) Int. Cl. F21L 4/04

(52) U.S. Cl. 362/253; 362/202

(57) ABSTRACT

A flashlight having function of indicating directions includes a bottom base, a tube body, a battery holder, a circuit board, a light-refracting shade, an upper cover and a compass indicating North Pole. When the batteries in the battery holder and the circuit board are electrically connected, the light emitting diodes on the circuit board will emit bright light, which is simultaneously focused by the light-refracting surface of the light refracting shade and projected outward through the light-transmitting hole of the upper cover. The light emitted by the flashlight of this invention is much brighter than that given out by a conventional common flashlight, and the compass indicating North Pole provided under the bottom of the bottom base is able to indicate directions.

### BACKGROUND OF THE INVENTION

1. Field of the Invention

This invention relates to a flashlight having function of indicating directions, particularly to one composed of a bottom base, a tube body, a battery holder, a circuit board, a light-refracting shade, an upper cover and a compass indicating north pole. When the batteries in the battery base and the circuit board are electrically connected, the light emitting diodes provided on the circuit board will emit bright light, which is simultaneously focused by the light-refracting surface of the light refracting shade and projected outward through the light-transmitting hole of the upper cover. The flashlight of this invention is able to give out brighter light than a common flashlight, and it is provided with a compass indicating north pole under the bottom base for indicating directions, able to increase lighting brightness and easy to be carried about.

2. Description of the Prior Art

A conventional flashlight used only for lighting is provided with a conventional light bulb for emitting light, but the brightness of the light bulb will gradually fade after the light bulb has been used for a period of time; therefore, the light bulb of the conventional flashlight does not have a long service life and must be frequently replaced with a new one. Usually, when going out for mountaineering or hiking, people have to carry various outfits with them, such as a flashlight for lighting, a compass for indicating directions and the like. Thus, it will take much space for storing the outfits and cause much inconvenience in carrying them.

### SUMMARY OF THE INVENTION

The objective of the invention is to offer a flashlight having a function of indicating directions and easy to be carried about.

A first feature of the invention is a bottom base formed inside with a chamber provided therein with an electric conductor, having its inner wall provided with female threads and having a recessed chamber formed under the bottom. A tube body assembled on the bottom base is formed with a chamber in the interior and has its upper and lower end respectively provided with male threads. A battery holder received in the chamber of the tube body has plural batteries fitted inside and has two electric conductors respectively provided on the topside and under the bottom. A circuit board assembled on the battery holder has plural LED (light emitting diodes) provided on the topside and an electric conductor provided under the bottom. A light-refracting shade assembled on the circuit board has its topside formed with a recessed arc-shaped light-refracting surface with plural insert holes. An upper cover assembled on the tube body has its topside bored with a light-transmitting hole provided therein with a stop edge and its lower inner wall provided with female threads. A compass indicating North Pole is received in the recessed chamber under the bottom of the bottom base.

A second feature of the invention is a bottom base formed inside with a chamber provided therein with an electric conductor, having its inner wall provided with female threads and having a recessed chamber formed under the bottom. A tube body assembled on the bottom base has its interior formed with a chamber and its upper and lower end respectively provided with male threads. A battery holder received in the chamber of the tube body has plural batteries fitted inside and has two electric conductors respectively provided on the topside and under the bottom. A circuit board assembled on the battery holder is provided with plural LED on the topside and an electric conductor provided under the bottom. A light-refracting shade assembled on the circuit board has its topside formed with a recessed arc-shaped light-refracting surface with plural insert holes. An upper cover assembled on the tube body has its topside bored with a light-transmitting hole having a stop edge provided therein and its lower inner wall provided with female threads. A compass is received in the recessed chamber under the bottom of the bottom base.

### BRIEF DESCRIPTION OF DRAWINGS

This invention will be better understood by referring to the accompanying drawings, wherein:

FIG. 1 is an exploded perspective view of a first preferred embodiment of a flashlight having function of indicating directions in the present invention;

FIG. 2 is a side cross-sectional view of the first preferred embodiment of the flashlight having function of indicating directions in the present invention;

FIG. 3 is a perspective view of the first preferred embodiment of the flashlight having function of indicating directions in the present invention;

FIG. 4 is a perspective view of the first preferred embodiment of the flashlight placed inversely in the present invention; and,

FIG. 5 is a perspective view of a second preferred embodiment of a flashlight placed inversely in the present invention.

### DETAILED DESCRIPTION OF THE PREFERRED EMBODIMENT

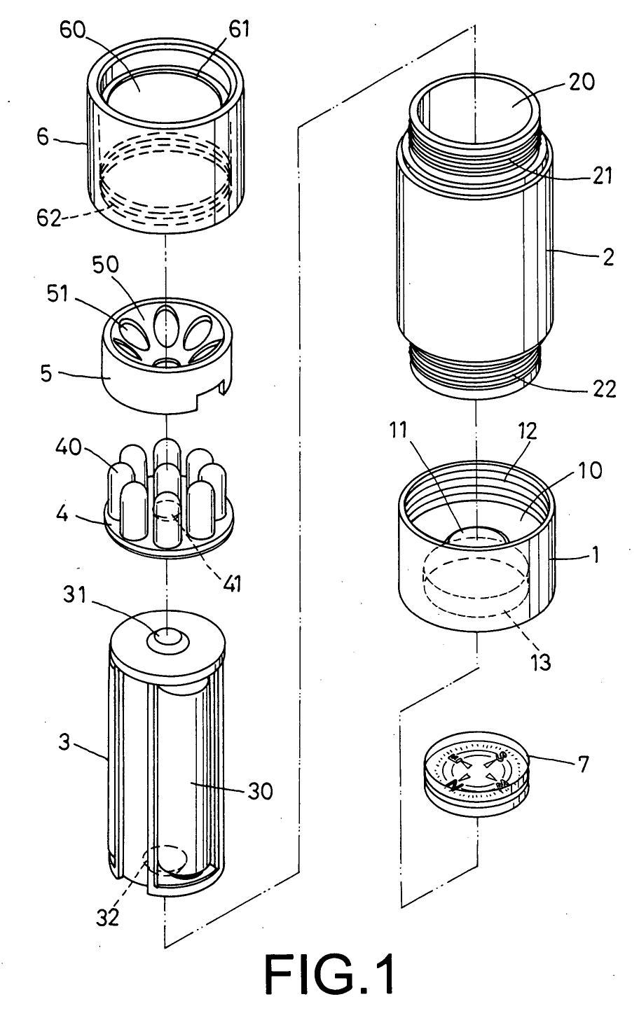

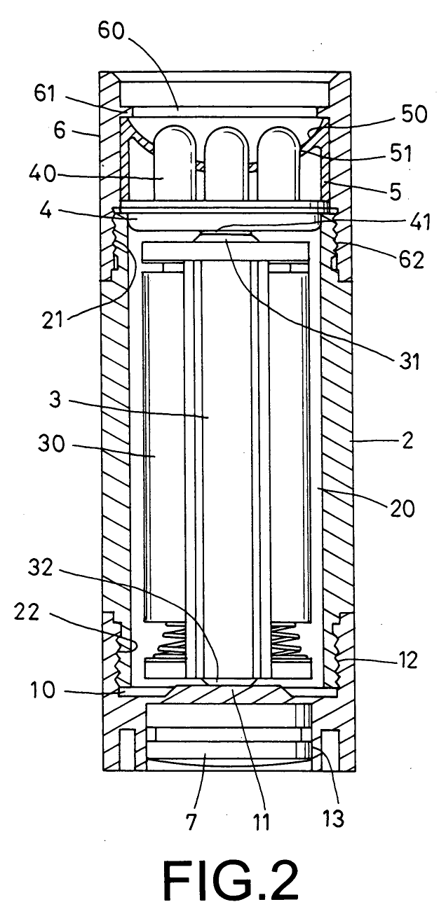

A first preferred embodiment of a flashlight having function of indicating directions in the present invention, as shown in FIGS. 1 and 2, includes a bottom base 1, a tube body 2, a battery holder 3, a circuit board 4, a light-refracting shade 5, an upper cover 6 and a compass 7 combined together.

The bottom base 1 has its interior formed with a chamber 10 provided therein with an electric conductor 11 and having its inner wall provided with female threads 12. The bottom base 1 is further formed with a recessed chamber 13 in the lower portion.

The tube body 2 to be assembled on the bottom base 1 has its interior formed with a chamber 20, and its upper and lower end respectively provided with male threads 21, 22.

The battery holder 3 to be received in the chamber 20 of the tube body 2 has plural batteries 30 fitted in the interior, and two electric conductors 31, 32 respectively provided on the topside and under the bottom.

The circuit board 4 to be assembled on the upper end of the battery holder 3 is provided with plural LED 40 on the topside and an electric conductor 41 under the bottom.

The light-refracting shade 5 to be assembled on the circuit board 4 has its topside formed with a recessed arc-shaped light-refracting surface 50 with plural insert holes 51.

The upper cover 6 to be threadably combined with the upper end of the tube body 2 has its topside bored with a light-transmitting hole 60 having an annular stop edge 61 provided therein and its lower inner wall formed with female threads 62.

The compass 7 indicating north pole is received in the recessed chamber 13 under the bottom of the bottom base 1.

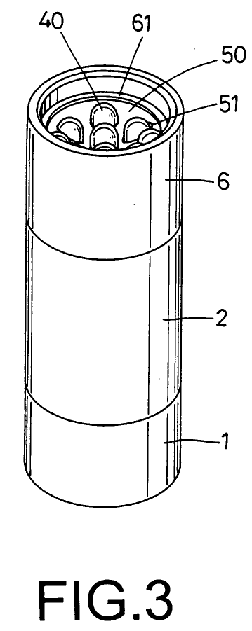

In assembling, as shown in FIGS. 1, 2 and 3, firstly, the bottom base 1 is threadably combined with the lower end of the tube body 2 by having its female threads 12 engaging the male threads 22 of the tube body 2. Next, the battery holder 3 is received in the chamber 20 of the tube body 2, letting the bottom of the battery holder 3 closely contact with the electric conductor 11 inside the bottom base 1. Then, the circuit board 4 is assembled under the light-refracting shade 5, letting the LED 40 respectively inserted upward through the insert holes 51 of the light-refracting shade 5. Subsequently, the light-refracting shade 5 together with the circuit board 4 are fitted in the upper cover 6, letting the upper edge of the light-refracting shade 5 push against the lower side of the stop edge 61 inside the upper cover 6 and afterward, the upper cover 6 is threadably combined with the upper end of the tube body 2 by having its female threads 62 screwed with the male threads 21 of the tube body 2. Lastly, the compass 7 indicating North Pole is fitted in the recessed chamber 13 under the bottom base 1 to finish assembly the flashlight conveniently and quickly.

In using, the upper cover 6, the tube body 2 and the bottom base 1 are screwed tight with one another to let the electric conductor 41 under the circuit board 4 closely contact with the electric conductor 31 on the topside of the battery holder 3 and also let the electric conductor 32 under the battery holder 3 closely contact with the electric conductor 11 of the bottom base 1 so as to make electric connection. At this time, the light emitting diodes 40 on the circuit board 4 will emit bright light, which is simultaneously focused by the light-refracting surface 50 of the light-refracting shade 5 and projected outward through the light-transmitting hole 60 of the upper cover 6. Substantially, the light given out by the flashlight of this invention is much brighter than that given out by a common flashlight.

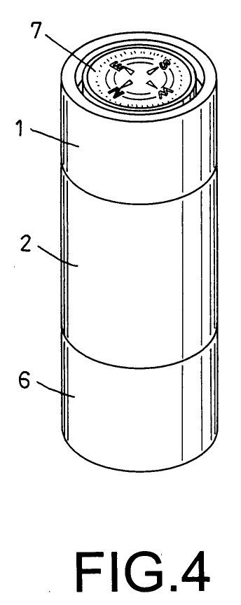

Further, the North Pole 7 received in the recessed chamber 13 under the bottom base 1 is able to indicate directions, as shown in FIG. 4.

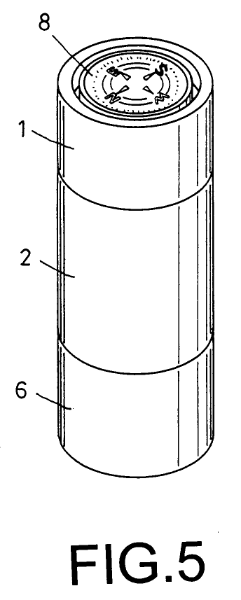

A second preferred embodiment of a flashlight having function of indicating directions in the present invention, as shown in FIG. 5, has the same structure and function as those described in the first preferred embodiment, except that a compass 8 takes the place of the North Pole 8.

As can be understood from the above description, this invention has the following advantages.
1. It has both functions of emitting extremely bright light and indicating directions.
2. It is small and easy to be carried and used.

While the preferred embodiments of the invention have been described above, it will be recognized and understood that various modifications may be made therein and the appended claims are intended to cover all such modifications that may fall within the spirit and scope of the invention.

What is claimed is:

1. A flashlight having function of indicating directions comprising:
a bottom base formed with a chamber in the interior, said chamber provided with an electric conductor inside, said chamber having its inner wall provided with female threads, said bottom base further formed with a recessed chamber in a lower portion;
a tube body assembled on said bottom base, said tube body formed with a chamber in the interior, said tube body having its upper and lower end respectively provided with male threads;
a battery holder received in said chamber of said tube body, said battery base having plural batteries fitted therein, said battery holder having two electric conductors respectively provided on the topside and under the bottom;
a circuit board positioned on an upper end of said battery holder, said circuit board provided with plural LED on the topside, said circuit board having an electric conductor provided under the bottom;
a light-refracting shade assembled on said circuit board, said light-refracting shade having its topside formed with a recessed arc-shaped light-refracting surface, said light-refracting surface bored with plural insert holes;
an upper cover threadably combined with the upper end of said tube body, said upper cover having its topside bored with a light-transmitting hole, said light-transmitting hole provided with an annular stop edge in the interior, said upper cover having its lower inner wall provided with female threads; and,
a compass indicating North Pole received in said recessed chamber under said bottom base.

2. A flashlight having function of indicating directions comprising:
a bottom base formed with a chamber in the interior, said chamber provided with an electric conductor inside, said chamber having its inner wall provided with female threads, said bottom base further formed with a recessed chamber in a lower portion;
a tube body assembled on said bottom base, said tube body formed with a chamber in the interior, said tube body having its upper and lower end respectively provided with male threads;
a battery holder received in said chamber of said tube body, said battery holder having plural batteries fitted in the interior, said battery holder having two electric conductors respectively provided on the topside and under the bottom;
a circuit board positioned on said battery holder, said circuit board provided with plural LED on the topside, said circuit board having en electric conductor provided under the bottom;
a light-refracting shade assembled on said circuit board, said light-refracting shade having its topside formed with a recessed arc-shaped light-refracting surface, said light-refracting surface bored with plural insert holes;
an upper cover threadably combined with the upper end of said tube body, said upper cover having its topside bored with a light-transmitting hole, said light-transmitting hole provided with an annular stop edge in the interior, said upper cover having its lower inner wall provided with female threads; and,
a compass indicating South Pole fitted in said recessed chamber of said bottom base.
